(19) United States
(12) Patent Application Publication
(10) Pub. No.: US 2010/0081570 A1
(43) Pub. Date: Apr. 1, 2010

(54) HERBICIDE COMPOSITIONS

(75) Inventors: ANDREW J. POSS, KENMORE, NY (US); MICHAEL VAN DER PUY, AMHERST, NY (US); RAJIV R. SINGH, GETZVILLE, NY (US); GEORGE J. SAMUELS, WILLIAMSVILLE, NY (US); DAVID NALEWAJEK, WEST SENECA, NY (US); CHERYL L. CANTLON, CLARENCE CENTER, NY (US)

Correspondence Address: HONEYWELL/FOX ROTHSCHILD;Patent Services, 101 Columbla Road, Morristown, NJ, 07962, US

(73) Assignee: HONEYWELL INTERNATIONAL INC., MORRISTOWN, NJ (US)

(21) Appl. No.: 12/566,210

(22) Filed: Sep. 24, 2009

Related U.S. Application Data
(60) Provisional application No. 61/100,425, filed on Sep. 26, 2008.

(51) Int. Cl. A01N 29/00

(52) U.S. Cl. 504/118; 504/356

(57) ABSTRACT

Chloropentafluoropropene is employed as a herbicide for the effective control of undesirable spermatophyte growth.

### CROSS-REFERENCE TO RELATED APPLICATIONS

The application claims the priority benefit of U.S. Provisional Application No. 61/100,425, filed Sep. 26, 2008, which is incorporated herein by reference.

### BACKGROUND

1. Field of Invention

This invention generally relates to methods for killing or inhibiting growth of plants. More particularly, the invention relates to herbicides containing a chlorofluoro-olefin (CFO).

2. Description of Prior Art

Methyl bromide (CH₃Br) is the most widely used and most universal fumigant in the world. It is used extensively for soil fumigation, as a commodity quarantine treatment (export and imports), to control a variety of pests on numerous crops, and as a structural fumigant for wood destroying pests.

According to the Montreal Protocol of 1992, methyl bromide was categorized as an ozone depleting chemical with an ozone depleting potential (ODP) of greater than 0.2 compared to trichlorofluoromethane (CFC-11), a refrigerant used as a reference gas having an ODP of 1. Compounds that contain chlorine or bromine are capable of the destruction of the earth's protective ozone layer.

The global warming potential (GWP) is the relative ability of a chemical to cause global warming on a per-pound-released basis. The halons have both high ODP and GWP values, which makes them serious environmental threats. Tapscott in U.S. Pat. No. 5,759,430 teaches that the presence of a carbon-carbon double bond in the molecule affords a chromophoric group which can be easily photolyzed in the troposphere.

Subsequent to the Montreal Protocol, the production levels of methyl bromide were frozen at the 1991 production levels. Methyl bromide was targeted for a 5-year phase out by the year 2005 in accordance with the Montreal Protocol. In 2005, 9575 metric tons of methyl bromide was allocated for critical uses. The large volume of critical use exemptions is due to the fact that there is no drop-in replacement to methyl bromide. A drop-in replacement means that methodology, equipment, production system, etc., do not have to be changed significantly and that a comparable amount of material can be used for the same target. That is, the alternative material is applied at nearly the same rate and with the same equipment as methyl bromide. All the current methyl bromide alternatives (1,3-dichloropropene, chloropicrin, metham sodium, methyl iodide, etc.) fail as drop-in replacements based on physical handling requirements, performance or economics. These alternatives are commonly applied as mixtures of two or more of the individual compounds in order to attempt to produce a broader spectrum product similar to methyl bromide.

In U.S. Pat. No. 2,785,984, 2-chloro-1,1,3,3,3-pentafluoropropene (CFO-1215xc or 2-chloropentafluoropropene) was reported to show efficacy against confused flower beetles and black carpet beetles for structural fumigation. However, as taught in U.S. Pat. No. 5,518,692 (and WO 97/44127), it is not possible “to predict that an agent having utility in control of insect populations in stored grain would in fact have any utility whatsoever in fumigation of soils for effective control of plant pathogens, nematodes, bacteria and weeds.”

As demonstrated by Ohr, (Plant Disease 1996, 731-735) and concluded by Zhang (Pestic. Sci. 1998, 53, 71-79), weeds are generally more resistant to fumigation than nematodes or most soil-borne plant-pathogenic fungi. A broadleaf species (Abutilon theophrastic Medik.) and a grass weed species (Loliium multiflorum Lam.) can be used as general indictors for most soil pests in fumigation experiments.

Thus, there remains a need for an environmentally friendly replacement for methyl bromide that serves as a spermatophyte growth inhibiting agent and that can be effectively applied as a soil fumigant and/or herbicide.

### SUMMARY OF INVENTION

Compositions comprising chloropentafluoropropene, particularly 2-chloro-1,1,3,3,3-pentafluoropropene (CFO-1215xc or 2-chloropentafluoropropene), unpredictably have been found to be effective for killing and/or inhibiting the growth of certain plants, particularly, seed bearing plants such as spermatophytes. Advantageously, 1215xc has physical properties comparable to methyl bromine—a widely used soil fumigant. For example, the physical properties of 1215xc, namely boiling point of 6.8° C. and melting point of −130° C. mimic the physical properties of methyl bromide (bp 4° C., mp −94° C.). The vapor pressure versus temperature curve of CFO-1215xc indicates that it is a gas at room temperature and would be applied as a liquefied gas for fumigation in the same manner as methyl bromide (see FIG. 1). However, unlike methyl bromide, 1215xc does not deplete the ozone layers and it has very low global warming potential (GWP) because it has a very short atmospheric lifetime. Therefore, CFO-1215xc is an excellent drop-in replacement for methyl bromide in herbicidal and/or soil fumigation applications.

Accordingly, one aspect of the present invention provides a method for controlling spermatophyte growth comprising contacting a viable plant seed or sprout with a composition comprising a herbicial amount of a chloropentafluoropropene, preferably 2-chloro-1,1,3,3,3-pentafluoropropene.

In another aspect of the invention, provided is a herbicide comprising chloropentafluoropropene, a carrier selected from agriculturally suitable propellants and solvents, and optionally at least one additional growth inhibiting agent selected from co-herbicides, fungicides, bactericides, and insecticides. In certain preferred embodiments, the herbicide is a nonselective preemergent.

### BRIEF DESCRIPTION OF THE DRAWING

FIG. 1 shows the comparative pressure/temperature curves for 1215xc and methyl bromide.

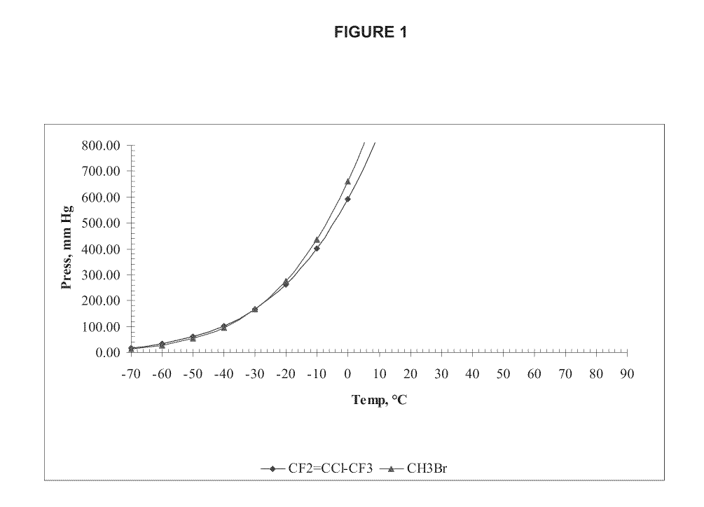

### DETAILED DESCRIPTION OF PREFERRED EMBODIMENTS OF THE INVENTION

Chloropentafluoropropene, particularly 2-chloro-1,1,3,3,3-pentafluoropropene (CFO-1215xc or 2-chloropentafluoropropene) has been found to kill and/or inhibit the growth of certain plants. In certain preferred embodiments, 1215xc is used as a preemergent herbicide and/or soil fumigant to prevent the germination of plant seeds in soil, such as crop land, thereby ridding the soil of undesirable viable seeds that could subsequently grow as weeds. Over time, the herbicidal effect of chloropentafluoropropene in the soil will dissipate and the soil will be able to support the growth of desirable plants and crops.

Generally, the germination of any seed producing plant is affected by contacting the seed or spout with chloropentafluoropropene. For example, the types of spermatophytes whose growth is controlled by chloropentafluoropropene include monocots, including grasses such as Loliium multiflorum Lam. (Italian rye grass) and the like, and dicots, including broad-leaf weeds such as Abutilon theophrastic Medik. (velvet leaf) and the like.

In certain preferred embodiments, chloropentafluoropropene is applied to a medium, such as potting soil, top soil (including packaged, residential lawns and gardens, landscaping, crop land, and the like), and mulch to inhibit the growth of weeds from any seeds that might be in the medium. After the chloropentafluoropropene renders the seeds unviable, it dissipates from the medium, leaving a medium that can then be used to cultivate desirable plants with a reduced prevalence of undesirable weeds. For example, soil fumigation with 1215xc in accordance with the present invention has been found to be extremely effective for the substantial or complete elimination of a wide variety of weeds via preventing germination of the weeds' seeds. For purposes of the present invention, substantial elimination of a viable seeds is intended to mean reduction in the population of the viable seeds by about 90%, more preferably about 95%, and most preferably about 100%. Accordingly, the term “herbicidal amount”, with respect to the application of chloropentafluoropropene, means the amount of chloropentafluoropropene required to prevent the germination of a majority of the contacted seeds or otherwise render a majority of the contacted seeds or sprouts unviable, preferably within the present limits of customary means employed for the detection thereof.

A wide range of application rates of 1215xc have been found suitable in accordance with the present invention. Those skilled in the art could readily determine the optimum amount and rates of application for any given combination of crops, soils, and weeds. The herbicidal amount is dependent upon factors such as the type of weed targeted, the composition and density of the horticultural medium, and the method of delivering the herbicidal composition to the targeted seeds. Examples of horticultural medium include top soil (having various amounts of sand, silt, and/or clay), potting soil, peat, perlite, gravel, mulch, and the like. Examples of delivery methods include, but are not limited to, fumigation via soil injection and enclosed fumigation, such as tent fumigation. When applied to a horticultural medium such as top soil having a density of about 1 to about 2 gm/cm³, a herbicidal amount is preferably from about 0.05 to about 2 pounds of 1215xc per cubic foot of medium. In certain embodiments, a herbicidal amount is about 0.05 to about 0.2 pounds of 1215xc per cubic foot of medium, while in other embodiments, a herbicidal amount is about 0.2 to about 0.4 pounds of 1215xc per cubic foot of medium. In yet other embodiments, a herbicidal amount is about 0.4 to about 0.7 pounds of 1215xc per cubic foot of medium. And in certain embodiments a herbicidal amount is about 0.7 to about 2.0 pounds of 1215xc per cubic foot of medium. These ranges may be applied to other mediums with other densities as well. A concentration of about 0.53 lb of 1215xc per cubic foot of top soil is sufficient to prevent the germination of a majority of types of seeds commonly found in crop land.

Application of 1215xc in accordance with the present invention may be effected by a number of different procedures as are currently routinely employed for soil treatments with methyl bromide. Thus, for example, 1215xc may be applied to the soil by tractor mounted injectors on tines, manually in canisters and via an existing irrigation system or as a gas through lay fiat tubing. In certain embodiments, 1215xc may advantageously be pre-heated by passage through a heat exchanger prior to delivery; pre-heating vaporizes 1215xc for more rapid and even distribution and increases its activity. In addition, a carrier such as water or agriculturally suitable solvent (e.g., lower alcohols, acetone, mixtures of water with acetone or alcohol, etc.) may be used to assist in the dispersion of the composition comprising 1215xc in the soil. Further, it is contemplated as within the scope of the invention to apply mixtures of 1215xc with other fumigants (e.g., carbon disulfide or chloropicrin) in ratios comparable to those currently employed with methyl bromide. For example, a mixture of 67% 1215xc and 33% chloropicrin would be effective, as would a mixture of about 98% 1215xc with 2% chloropicrin as a warning agent. In general, it is preferred that tarping be undertaken immediately following fumigation. The duration of the fumigation treatment and the application and removal of tarps should be consistent with contemporary practice in connection with methyl bromide treatments.

The invention may be better understood with reference to the accompanying examples, which are intended for purposes of illustration only and should not be construed as in any sense limiting the scope of the invention as defined in the claims appended hereto.

### EXAMPLES

### Examples 1 and 2

Seeds from the broadleaf species Abutilon theophrastic Medik. or velvet leaf and the grass weed species Loliium multiflorum Lam. or Italian rye grass were used in all germination experiments. A single batch of seeds for each species was used and Abutilon theophrastic Medik. seeds were scarified with 55° C. water for two days to induce germination. Blank germination tests demonstrated that more than 95% of the chemically untreated seeds of both weed species germinated. Capital Forest Products premium topsoil was used as the soil in all experiments. The topsoil was placed in a vacuum oven at 110° C. for 7 days to sterilize the soil and remove all moisture.

In a 120 mL pressure vessel, ten seeds of each species were thoroughly mixed with 50 mL (approximately 20 grams) of soil and 6 mL of water. The filled tubes were kept at room temperature for 12-15 hr to allow the seeds to imbibe water before treatment. The tubes were sealed, evacuated and 0.43 grams of 1215xc added. The tubes were thoroughly mixed and placed horizontally on the laboratory bench at room temperature for two days. The contents of each bottle were transferred to a plastic sterile Petri dish containing 7 mL of water. The Petri dishes were sealed with parafilm and incubated in the laboratory at room temperature. After 5 days, the number of germinated seeds was counted. As shown in Table 1, none of the seeds treated with 1215xc showed any signs of germination.

TABLE 1
No. Seeds Germinated

| | Example 1 | Example 2 |
|---|---|---|
| Fumigant | Abutilon theophrastic | Loliium multiflorum |
| | Medik. | Lam. |
| Blank | 6 | 10 |
| 1215xc | 0 | 0 |

These fumigation tests demonstrate that herbicidal amounts of 1215xc prevent germination of the seeds of the broadleaf species Abutilon theophrastic Medik. and the grass weed species Loliium multiflorum Lam. Other monocots and dicots seeds likewise will experience little or no germination after exposure to 1215xc.

### Comparative Examples 3 and 4

The procedure of example 1 was used with 0.004 grams of 1215xc. This amount corresponds to 0.5 lbs per 1,000 cu.ft., which purportedly is useful as an insecticide.

TABLE 2
No. Seeds Germinated

| | Example 3 | Example 4 |
|---|---|---|
| Fumigant | Abutilon theophrastic | Loliium multiflorum |
| | Medik. | Lam. |
| Blank | 10 | 10 |
| 1215xc | 10 | 10 |

These fumigation tests demonstrated that germination of seeds of the broadleaf species Abutilon theophrastic Medik. and the grass weed species Loliium multiflorum Lam. occurred with low amounts of 1215xc.

Having thus described a few particular embodiments of the invention, it will be apparent to those skilled in the art, in view of the teachings contained herein, that various alterations, modifications, and improvements not specifically described are available and within the scope of the present invention. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for controlling spermatophyte growth comprising contacting a viable plant seed or sprout with a composition comprising a herbicidal amount of a chloropentafluoropropene.

2. The method of claim 1 wherein said chloropentafluoropropene is 2-chloro-1,1,3,3,3-pentafluoropropene.

3. The method of claim 2 wherein said contacting occurs while said seed or sprout is in a horticultural medium.

4. The method of claim 3 wherein said horticultural medium is selected from the group consisting of top soil, potting soil, peat, perlite, gravel, and mulch.

5. The method of claim 3 wherein said horticultural medium is top soil.

6. The method of claim 3 wherein said horticultural medium is potting soil.

7. The method of claim 3 wherein said horticultural medium is mulch.

8. The method of claim 3 wherein said horticultural medium is selected from the group consisting of soil, potting soil, and mulch and said herbicidal amount is about 50 to about 1000 pounds of 2-chloro-1,1,3,3,3-pentafluoropropene per 1000 cubic feet of said horticultural medium.

9. The method of claim 8 wherein said herbicidal amount is from about 400 to about 600 pounds of 2-chloro-1,1,3,3,3-pentafluoropropene per 1000 cubic feet of said horticultural medium.

10. The method of claim 8 wherein said composition is a fumigant.

11. The method of claim 10 wherein said contacting involves injecting said fumigant into said plant growth medium.

12. The method of claim 11 wherein said contacting occurs for at least about 1 hour.

13. The method of claim 12 wherein said contacting occurs for about 1 to about 24 hours.

14. A herbicide comprising chloropentafluoropropene and a carrier selected from agriculturally suitable propellants and solvents.

15. The herbicide of claim 14 wherein said solvent selected from the group consisting of water, lower alcohols, and ketones.

16. The herbicide of claim 14 wherein said propellant is selected from carbon dioxide and a C₃-C₅ hydrofluoroolefin.

17. The herbicide of claim 14 further comprising at least one additional growth inhibiting agent selected from co-herbicides, fungicides, bactericides, and insecticides.

18. The herbicide of claim 14 further comprising at least one compound selected from the group consisting of dichlorotetrafluoropropenes, methyl bromide, methyl iodide, chloropicrin, and metham sodium.

19. The herbicide of claim 14 wherein said herbicide is a preemergent herbicide.
